(19) United States
(12) Patent Application Publication
(10) Pub. No.: US 2026/0234378 A1
(43) Pub. Date: Aug. 13, 2026

(54) POLYOLEFIN COMPOSITION CONTAINING A RECYCLED MATERIAL

(71) Applicant: Basell Poliolefine Italia S.r.l., Milano (IT)

(72) Inventors: Claudio Cavalieri, Ferrara (IT); Monica Galvan, Ferrara (IT); Eleonora Ciaccia, Ferrara (IT)

(73) Assignee: Basell Poliolefine Italia S.r.l., Milano (IT)

(21) Appl. No.: 19/127,321

(22) PCT Filed: Oct. 16, 2023
(86) PCT No.: PCT/EP2023/078608

§ 371 Date: May 5, 2025

(30) Foreign Application Priority Data
Nov. 7, 2022 (EP) 22205693.9

(51) Int. Cl. C08L 23/08; C08K 5/524

(52) U.S. Cl. CPC C08L 23/08; C08K 5/524; C08L 2203/16; C08L 2205/025; C08L 2205/03; C08L 2207/20; C08L 2314/02

(57) ABSTRACT

A polyolefin composition (I) made from or containing:
(A) 70-97% by weight of a polypropylene composition made from or containing:
   20-45% by weight of a polymer fraction (a)
      made from or containing a propylene homopolymer, a propylene copolymer, or a combination thereof, and having solubility in xylene equal to or lower than 10% by weight; and
   55-80% by weight of a polymer fraction (b)
      made from or containing a copolymer of ethylene with propylene, a CH₂═CHR alpha-olefin, or a combination thereof, and
      having solubility in xylene equal to or greater than 60% by weight,
wherein the ethylene copolymer containing more than 50% by weight of ethylene units, and
(B) 3-30% by weight of a recycled styrene block copolymer (rSBC), having a melt flow rate 2.0-15 g/10 min.

### FIELD OF THE INVENTION

In general, the present disclosure relates to the field of chemistry. More specifically, the present disclosure relates to polymer chemistry. In particular, the present disclosure relates to a polyolefin composition made from or containing recycled elastomeric material.

### BACKGROUND OF THE INVENTION

In some instances, polypropylene compositions have elastic properties and retain thermoplastic behavior. In some instances, these polypropylene compositions are prepared by sequential copolymerization of propylene, optionally containing minor quantities of olefin comonomers, and of ethylene/propylene or ethylene/alpha-olefin copolymers. In some instances, catalysts based on halogenated titanium compounds supported on magnesium chloride are used for this purpose.

In some instances, specifications for extruded parts of interior car trims, such as artificial leather, include reduced stickiness as well as retention of haptic and mechanical properties.

In some instances, blends of heterophasic polypropylene compositions and elastomers, like styrene block copolymers, retain softness and have abrasion resistance. In some instances, these blends are used to produce injection molded or extruded articles, like floor mats, hoses, handles and grips, for the automotive field.

In some instances, car manufacturers seek to reduce the amount of virgin plastic used in the production of vehicles, thereby increasing the demand of plastic materials containing recycled plastic.

### SUMMARY OF THE INVENTION

In a general embodiment, the present disclosure provides a polyolefin composition (I) made from or containing:
(A) from 70% to 97% by weight of a polypropylene composition made from or containing:
   from 20% to 45% by weight of a polymer fraction (a)
      made from or containing a propylene polymer selected from the group consisting of propylene homopolymers, propylene copolymers and combinations thereof, and
      having solubility in xylene at 25° C. (XS(a)) equal to or lower than 10.0% by weight, based on the weight of the fraction (a),
wherein the propylene copolymers containing up to and including 15.0% by weight, based on the weight of the propylene copolymer, of units derived from a comonomer selected from the group consisting of ethylene and a CH₂═CHR alpha-olefin, wherein R is a linear or branched C2-C8 alkyl group; and
   from 55% to 80% by weight of a polymer fraction (b)
      made from or containing a copolymer of ethylene with a comonomer selected from the group consisting of propylene, a CH₂═CHR alpha-olefin, wherein R is a linear or branched C₂-C₈ alkyl group, and combinations thereof, and having solubility in xylene at 25° C. (XS(b)) equal to or greater than 60.0% by weight, based on the weight of the fraction (b),
wherein the ethylene copolymer contains more than 50.0% by weight of units derived from ethylene, based on the weight of the ethylene copolymer,
wherein the amounts of fractions (a) and (b) are based on the total weight of (a)+(b), and
(B) from 3% to 30% by weight of a recycled styrene block copolymer (rSBC), having a melt flow rate MFR(B) (ISO 1133-1:2011, 230° C./2.16 kg) ranging from 2.0 to 15.0 g/10 min,
wherein the amounts of (A) and (B) are based on the total amount of (A)+(B).

In some embodiments, the polyolefin composition (I) is used to produce articles, like films or sheets. In some embodiments, the articles are used for interior vehicles trims, like artificial leather.

In some embodiments, the present disclosure provides an article made from or containing the polyolefin composition (I). In some embodiments, the article is a film or sheet.

While multiple embodiments are disclosed, other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified.

In the present disclosure, the total weight of a composition sums up to 100%, unless otherwise specified.

In the present disclosure, when the term “comprising” is referred to a polymer, a plastic material, a polymer composition, mixture or blend, the term should be construed to mean “comprising or consisting essentially of”. In the present disclosure, term “consisting essentially of” means that, in addition to the specified components, the plastic material, the polymer composition, the polymer mixture, or the polymer blend may be further made from or containing other components, provided that the characteristics of the material are not materially affected by the presence of the other components. In some embodiments, the other components are selected from the group consisting of catalyst residues, antistatic agents, processing aids, melt stabilizers, light stabilizers, antioxidants and antiacids.

In the present disclosure, the term “copolymer” is referred to a polymer deriving from the intentional polymerization of at least two different comonomers, that is, the term “copolymer” includes terpolymers.

In the present disclosure, the terms “pre-consumer waste” and “post-industrial waste” are synonyms and refer to a material diverted from the waste stream originating from a manufacturing process. In some embodiments, the materials are selected from the group consisting of material trimmings, faulty items, overstock raw materials, and excess inventory.

In the present disclosure, the term “post-consumer waste” refers to a material that is discarded after use by a final consumer.

In the present disclosure, the term “film” refers to a thin layer of material having thickness equal to or lower than 2000 μm.

In the present disclosure, the term “sheet” refers to a layer of material more than 2000 μm thick.

In some embodiments, the polyolefin composition (I) is made from or containing:
from 75% to less than 95% by weight, alternatively from 78% to 93% by weight, alternatively from 78% to 88% by weight, of the polypropylene composition (A), and
from more than 5% to 25% by weight, alternatively from 7% to 22% by weight, alternatively from 12% to 22% by weight, of the recycled styrene block copolymer (rSBC) (B),
wherein the amounts of (A) and (B) are based on the total amount of (A)+(B).

In some embodiments, the polyolefin composition (I) is made from or containing the individual components in various combinations.

In some embodiments, the polypropylene composition (A) is made from or containing:
from 20% to 45% by weight, alternatively from 25% to 40% by weight, of a polymer fraction (a)
made from or containing a propylene polymer selected from the group consisting of propylene homopolymers, propylene copolymers and combinations thereof, and
having solubility in xylene at 25° C. (XS(a)) equal to or lower than 10.0% by weight, alternatively equal to or lower than 6.0% by weight, alternatively ranging from 0.5% to 6.0% by weight, based on the weight of the fraction (a);
wherein the propylene copolymers containing up to and including 15.0% by weight, alternatively from 0.1% to 15.0% by weight, alternatively from 0.5% to 5.0% by weight, based on the weight of the propylene copolymer, of units derived from a comonomer selected from the group consisting of ethylene and a CH₂═CHR alpha-olefin, wherein R is a linear or branched C2-C8 alkyl group; and
from 55% to 80% by weight, alternatively from 60% to 75% by weight, of a polymer fraction (b)
made from or containing a copolymer of ethylene with a comonomer selected from the group consisting of propylene, a CH₂═CHR alpha-olefin, wherein R is a linear or branched C₂-C₈ alkyl group, and combinations thereof, and
having solubility in xylene at 25° C. (XS(b)) equal to or greater than 60.0% by weight, alternatively ranging from 60.0% to 90.0% by weight, alternatively from 65.0% to 85.0% by weight, alternatively from 70.0% to 80.0% by weight, based on the weight of the fraction (b),
wherein the ethylene copolymer contains more than 50.0% by weight, alternatively from 51.0% to 70.0% by weight, alternatively from 52.0% to 65.0% by weight, of units derived from ethylene, based on the weight of the ethylene copolymer,
wherein the amounts of fractions (a) and (b) are based on the total weight of (a)+(b).

In some embodiments, fraction (a) has at least one of the following properties:
being made from or containing a propylene polymer selected from the group consisting of propylene homopolymers, propylene copolymers and combinations thereof, wherein the propylene copolymers containing up to and including 15.0% by weight, alternatively from 0.1% to 15.0% by weight, alternatively from 0.5% to 5.0% by weight, based on the weight of the propylene copolymer, of units derived from a comonomer selected from the group consisting of ethylene, butene-1, hexene-1 and combinations thereof; or
a melt flow rate MFR(a) (ISO 1133-1:2011, 260° C./2.16 kg) ranging from 2.0 to 70 g/10 min, alternatively from 5.0 to 40 g/10 min. In some embodiments, units derived from a comonomer are ethylene. In some embodiments, the fraction (a) is made from or containing a propylene polymer selected from the group consisting of propylene homopolymers, propylene-ethylene copolymers made from or containing from 0.5% to 5.0% by weight of units derived from ethylene, based on the weight of the copolymer, and combinations thereof. In some embodiments, fraction (a) has a combination of the previously-described properties.

In some embodiments, fraction (b) is made from or containing a copolymer of ethylene with a comonomer selected from the group consisting of propylene, butene-1, hexene-1 and combinations thereof. In some embodiments, fraction (b) is made from or containing a copolymer of ethylene with propylene. In some embodiments, the ethylene copolymer contains more than 50.0% by weight, alternatively from 51.0% to 70.0% by weight, alternatively from 52.0% to 65.0% by weight, of units derived from the comonomer. In some embodiments, the comonomer is propylene.

In some embodiments, the polypropylene composition (A) has at least one of the following properties:
a melt flow rate MFR(A) ranging from 0.05 to 5.0 g/10 min. alternatively from 0.1 to 3.0 g/10 min, alternatively from 0.2 to 1.0 g/10 min; or
an intrinsic viscosity of the xylene soluble fraction at 25° C. XS(A) equal to or greater than 2.0 dl/g, alternatively ranging from 2.5 to 6.0 dl/g, alternatively from 3.0 to 5.0 dl/g; or
a flexural modulus equal to or lower than 600 MPa, alternatively ranging from 50 to 600 MPa, alternatively from 80 to 400 MPa, alternatively from 100 to 350 MPa, determined according to the method ISO 178:2010 on injection molded test specimens (80×10×4 mm) obtained according to the method ISO 1873-2:2007. In some embodiments, the polypropylene composition (A) has the previously-described properties.

In some embodiments, the polypropylene composition (A) is further made from or containing up to and including 5.0% by weight, alternatively from 0.01% to 5.0% by weight, of at least one additive (c) selected from the group consisting of nucleating agents, antistatic agents, anti-oxidants, light stabilizers, slipping agents, anti-acids, melt stabilizers, and combinations thereof, the amount of additive being based on the total weight of the polypropylene composition (A) made from or containing the additive, the total weight being 100%.

In some embodiments, the polypropylene composition (A) consists of the fraction (a) and the fraction (b). In some embodiments, the polypropylene composition (A) consists of the fraction (a), the fraction (b), and the additive (c).

In some embodiments, the polypropylene composition (A) is obtained by melt blending the components (a), (b), and optionally (c). In some embodiments, the polypropylene composition (A) is a reactor blend of the components (a) and (b), optionally melt blended with component (c), wherein the reactor blend is obtained by sequential polymerizing of the relevant monomers in the gas-phase in at least two, alternatively at least three, polymerization stages, wherein the second and each optional subsequent optional polymerization stage is carried out in the presence of the polymer produced and the catalyst system used in the immediately preceding polymerization stage.

In some embodiments, the polypropylene composition (A) is obtained by polymerizing the relevant monomers, in the presence of a highly stereospecific Ziegler-Natta catalyst systems made from or containing:
(1) a solid catalyst component made from or containing a magnesium halide support on which a Ti compound, having a Ti-halogen bond, is present, and a stereoregulating internal donor;
(2) optionally, an Al-containing cocatalyst; and
(3) optionally, a further electron-donor compound (external donor).

In some embodiments, the solid catalyst component (1) is made from or containing TiCl₄ in an amount securing the presence of from 0.5% to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes and combinations thereof.

In some embodiments, the stereoregulating internal donors are selected from the esters of mono or dicarboxylic organic acids such as benzoates, malonates, phthalates and certain succinates. In some embodiments, the internal donors are as described in U.S. Pat. No. 4,522,930A, European Patent No. EP045977A2, and Patent Cooperation Treaty Publication Nos. WO00/63261 and WO01/57099. In some embodiments, the stereoregulating internal donors are phthalic acid esters. In some embodiments, the stereoregulating internal donors are selected from the group consisting of diisobutyl phthalate, dioctyl phthalate, diphenyl phthalate, and benzyl-butyl phthalate.

In some embodiments, the magnesium halide support is magnesium dihalide.

In some embodiments, the amount of internal donor that remains fixed on the solid catalyst component (1) is 5 to 20% by moles, with respect to the magnesium dihalide.

In some embodiments, the preparation of catalyst components is as described in U.S. Pat. Nos. 4,399,054, 4,469,648, Patent Cooperation Treaty Publication No. WO98/44009A1 and European Patent No. EP395083A2.

In some embodiments, the solid catalyst component (1) is prepared by reacting a titanium compound of formula Ti(OR)q-yXy, where q is the valence of titanium and y is a number between 1 and q, with a magnesium chloride deriving from an adduct of formula MgCl₂·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100°-130° C.). Then, the adduct is mixed with an inert hydrocarbon immiscible with the adduct, thereby creating an emulsion which is quickly quenched causing the solidification of the adduct in form of spherical particles. In some embodiments, the procedure for the preparation of the spherical adducts is as disclosed in U.S. Pat. Nos. 4,399,054 and 4,469,648. In some embodiments, the resulting adduct is directly reacted with Ti compound or subjected to thermal controlled dealcoholation (80°-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80°-130° C. and maintained at this temperature for 0.5-2 hours. In some embodiments, the treatment with TiCl₄ is carried out one or more times. In some embodiments, the internal donor compound is added during the treatment with TiCl₄.

In some embodiments, the particles of solid catalyst component (1) have substantially spherical morphology and an average diameter ranging between 5 and 150 μm, alternatively from 20 to 100 μm, alternatively from 30 to 90 μm. As used herein, the term “substantially spherical morphology” refers to particles having the ratio between the greater axis and the smaller axis equal to or lower than 1.5, alternatively lower than 1.3.

In some embodiments, the catalyst system is made from or containing an Al-containing cocatalyst (2) selected from Al-trialkyls. In some embodiments, the Al-containing cocatalyst (2) is selected from the group consisting of Al-triethyl, Al-triisobutyl and Al-tri-n-butyl. In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the electron donor compound (3) is selected from the group consisting of silicon compounds, ethers, esters, amines, heterocyclic compounds, and ketones. In some embodiments, the heterocyclic compound is 2,2,6,6-tetramethylpiperidine.

In some embodiments, the silicon compounds are selected from the group consisting of methylcyclohexyldimethoxysilane (C-donor), dicyclopentyldimethoxysilane (D-donor) and mixtures thereof.

In some embodiments, the external electron donor compound (3) is used in an amount that provides a molar ratio between the organoaluminum compound and the external electron donor compound (3) of from 0.1 to 200, alternatively from 1 to 100, alternatively from 3 to 50.

In some embodiments, the polymerization temperature is in the range from 20° C. to 100° C. In some embodiments, the polymerization pressure is from 0.5 to 3.0 MPa.

In some embodiments, the molecular weight of a polymer is regulated by feeding a molecular weight regulator into the relevant polymerization reactor. In some embodiments, the molecular weight regulator is hydrogen. In some embodiments, the polypropylene composition (A) is subjected to a chemical treatment with a peroxide, thereby lowering the molecular weight and increasing the final melt flow rate.

In some embodiments, the polymerization processes for preparing the compositions are as described in European Patent No. EP472946, the relevant part of which is incorporated herein by reference

In some embodiments, the fraction (a) is obtained in a first gas-phase reactor and the fraction (b) is obtained in at least one second gas-phase reactor, alternatively in at least two gas-phase reactors in series, in the presence of the polymer prepared and the catalyst system used in the immediately preceding polymerization stage.

In some embodiments, the polypropylene composition (A) is a reactor blend produced by sequential polymerization in two reactors, wherein the amounts of components (a) and (b) correspond to the split between the two reactors. In some embodiments, the polypropylene composition (A) is a reactor blend produced by sequential polymerization in three reactors, wherein the amount of fraction (a) corresponds to the split of the first reactor with respect to the total amount of polymer produced and the amount of fraction (b) correspond to the cumulative split of the second and the third reactors together.

In some embodiments, the recycled styrene block copolymer rSBC (B) originates from a pre-consumer waste, a post-consumer waste or a combinations thereof. In some embodiments, the recycled styrene block copolymer rSBC (B) originates from a pre-consumer waste. In some embodiments, the recycled styrene block copolymer rSBC (B) originates from the mechanical recycling of at least one of the above-mentioned waste streams.

In some embodiments, the recycled styrene block copolymer (B) is made from or containing a block copolymer selected from the group consisting of polystyrene-polybutadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS) and mixtures thereof. In some embodiments, the recycled styrene block copolymer (B) is made from or containing a polystyrene-polybutadiene-polystyrene (SBS) block copolymer.

In some embodiments, component (B) is a recycled polystyrene-polybutadiene-polystyrene block copolymer (rSBS) originating from a pre-consumer waste, alternatively from the mechanical recycling of a pre-consumer waste.

In some embodiments, the recycled styrene block copolymer (B) is made from or containing up to and including 20.0% by weight, alternatively from 0.5% to 20.0% by weight, alternatively from 1.0% to 15.0% by weight, alternatively from 3.0 to 12.0% by weight, based on the weight of component (B), of a material selected from the group consisting of polypropylene, polyethylene, inorganic fillers, and mixtures thereof. In some embodiments, the inorganic filler is talc.

In some embodiments, the recycled styrene block copolymer (B) has at least one of the following properties:
a melt flow rate MFR(B) (ISO 1133-1:2011, 230° C./2.16 kg) ranging from 2.0 to 12.0 g/10 min, alternatively from 3.0 to 10.0 g/10 min; or
a tensile modulus ranging from 30 to 400 MPa, alternatively from 100 to 350 MPa, determined according to the method ISO 527-3 on injection molded test specimens obtained according to the method ISO 1873-2:2007; or
a Charpy impact value at 23° C., determined according to ISO 179-1eA on injection molded test specimens obtained according to ISO 1873-2:2007, equal to or greater than 50 kJ/m², alternatively equal to or greater than 60 kJ/m²; or
a Charpy impact value at −20° C., determined according to ISO 179-1eA on injection molded test specimens obtained according to ISO 1873-2:2007, equal to or greater than 80 kJ/m², alternatively equal to or greater than 90 kJ/m²; or
a Vicat softening temperature, determined according to the method ISO 306 (9.81N), in the range 35°-95° C., alternatively 40°-95° C., alternatively 70°-95° C., alternatively 75°-90° C.; or
a Heat Deflection Temperature (HDT), determined according to the method IS0075B (0.45 Mpa, Flat, 48 h), equal to or lower than 55° C., alternatively equal to or lower than 50° C. In some embodiments, the Charpy impact value at 23° C. ranges from 50 to 100 kJ/m², alternatively from 60 to 90 kJ/m². In some embodiments, the Charpy impact value at −20° C. and at −30° C. ranges from 80 to 150 kJ/m², alternatively from 90 to 130 kJ/m². In some embodiments, the HDT ranges from 30° to 55° C., alternatively from 35° to 50° C. In some embodiments, the recycled styrene block copolymer (B) has a combination of the previously-described properties.

In some embodiments, the polyolefin composition (I) is further made from or containing up to and including 50% by weight, alternatively from 0.05% to 50% by weight, of a component (C) selected from the group consisting of polyolefin additives, fillers, pigments and combinations thereof. In some embodiments, component (C) is selected from the group consisting of nucleating agents, extension oils, mineral fillers, organic pigments, and inorganic pigments. In some embodiments, mineral fillers, like talc and calcium carbonate, or inorganic fillers, improve some mechanical properties, such as flexural modulus and heat deflection temperature. In some embodiments, tale also has a nucleating effect.

In some embodiments, the component (C) is a nucleating agent and added in an amount ranging from 0.05 to 2.0% by weight, alternatively from 0.1 to 1.0% by weight, with respect to the total weight of the polyolefin composition (I).

In some embodiments, polyolefin composition (I) is obtained by blending components (A) and (B), and optionally the further component (C). In some embodiments, blending is achieved in the molten state. In some embodiments, the blending apparatus is a mixer or an extruder.

In some embodiments, the polyolefin composition (I) has a melt flow rate MFR(I) (ISO 1133-1:2011, 230° C./2.16 kg) ranging from 0.1 to 5.0 g/10 min, alternatively from 0.2 to 2.0 g/10 min, alternatively from 0.3 to 1.0 g/10 min.

In some embodiments, the polyolefin composition (I) has a tensile modulus, determined according to the method ISO 527-3 on injection molded test specimens obtained according to ISO 1873-2:2007, equal to or higher than the tensile modulus of the polypropylene composition (A).

In some embodiments, the tensile modulus Tmod(I) of the polyolefin composition (I) satisfies the following equation:

$$Tmod ( I ) \geq Tmod ( A ) W ( A ) + Tmod ( B ) W ( B )$$

wherein
Tmod(I) is the tensile modulus of the polyolefin composition (I), Tmod(A) is the tensile modulus of the polypropylene composition (A), W(A) is the relative amount of the polypropylene composition (A) in the polyolefin composition (I), Tmod(B) is the tensile modulus of the recycled styrene block copolymer (B) and W(B) is the relative amount of the recycled styrene block copolymer (B) in the polyolefin composition (I):
the tensile modulus is determined according to the method ISO 527-3 on injection molded test specimens obtained according to the method ISO 1873-2:2007; and
the relative amounts of components (A) and (B) are referred to the sum of components (A)+(B).

In some embodiments, the polyolefin composition (I) has thermal properties, like Vicat softening temperature and Heat Deflection Temperature (HDT), comparable to the thermal properties of the polypropylene composition (A).

In some embodiments, the impact properties at 23° C., as determined by the Charpy impact test, of the polyolefin composition (I) are in line with the impact properties of the polypropylene composition (A).

In some embodiments, the polyolefin composition (I) is for producing injection molded or extruded articles. In some embodiments, the present disclosure provides an article made from or containing the polyolefin composition (I).

In some embodiments, the article is an extruded article, like a film or sheet.

In some embodiments and due to haptic and stickiness properties, the film or sheet for use as artificial leather. In some embodiments, the artificial leather is used in the automotive field.

In some embodiments, the features are not inextricably linked to each other. In some embodiments, ranges of a feature are combined with ranges of a different feature, independently.

### EXAMPLES

The following examples are illustrative and not intended to limit the scope of the disclosure.

### Characterization Methods:

Melt Flow Rate: Determined according to the method ISO 1133-1:2011 (230° C./2.16 kg).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes, and maintained at 25° C. with stirring for the last 10 minutes. The formed solid was filtered on quick filtering paper (for example, Whatman filtering paper grade 4 or 541). 100 ml of the filtered solution (Si) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XS_{A} values were experimentally determined. The fraction of component (B) soluble in xylene at 25° C. (XS_{B}) was calculated from the formula:

$$XS = W ( A ) \times ( {XS}_{A} ) + W ( B ) \times ( {XS}_{B} )$$

wherein W(A) and W(B) are the relative amounts of components (A) and (B), respectively, and W(A)+W(B)=1.

Intrinsic viscosity of the xylene soluble fraction: To calculate the value of the intrinsic viscosity IV, the flow time of a polymer solution was compared with the flow time of the solvent tetrahydronaphthalene (THN). A glass capillary viscometer of Ubbelohde type was used. The oven temperature was adjusted to 135° C. Before starting the measurement of the solvent flow time t0, the temperature was stable (135°±0.2° C.). Sample meniscus detection for the viscometer was performed by a photoelectric device.

Sample preparation: 100 ml of the filtered solution (S1) were poured into a beaker, and 200 ml of acetone were added under vigorous stirring. Precipitation of insoluble fraction was complete as evidenced by a clear solid-solution separation. The suspension was filtered on a weighed metallic screen (200 mesh). The beaker was rinsed. The precipitate was washed with acetone, thereby removing the o-xylene. The precipitate was dried in a vacuum oven at 70° C. until a constant weight was reached. 0.05 g of precipitate were dissolved in 50 ml of tetrahydronaphthalene (THN) at a temperature of 135° C. The efflux time t of the sample solution was measured and converted into a value of intrinsic viscosity [η], using Huggins' equation (Huggins, M. L., J. Am. Chem. Soc. 1942, 64, 11, 2716-2718) and the following data:
concentration (g/dl) of the sample;
the density of the solvent at a temperature of 135° C.;
the flow time t0 of the solvent at a temperature of 135° C. on the same viscometer.
   A single polymer solution was used to determine [η].

Comonomer content of polypropylene-ethylene polymers: determined by IR using Fourier Transform Infrared Spectrometer (FTIR). The spectrum of a pressed film of the polymer was recorded in absorbance vs. wavenumbers (cm-1). The following measurements were used to calculate ethylene content:
Area (At) of the combination absorption bands between 4482 and 3950 cm⁻¹ which was used for spectrometric normalization of film thickness;
a linear baseline was subtracted in the range 790-660 cm⁻¹ and the remaining constant offset was eliminated; and
the content of ethylene was obtained by applying a Partial Least Square (PLS1) multivariate regression to the 762-688 cm⁻¹ range.
   The method was calibrated using polymer standards based on 13C NMR analyses.
   Sample preparation: Using a hydraulic press, a thick sheet was obtained by pressing about 1 g of sample between two aluminum foils. Pressing temperature was 180±10° C. (356° F.) with about 10 kg/cm² of pressure for about one minute. There was a minimum of two pressing operations for each specimen. A small portion was cut from the sheet to mold the film. The film thickness was between 0.02-0.05 cm.

Injection molded specimens: test specimens 80×10×4 mm were obtained according to the method ISO 1873-2:2007

Flexural Modulus: determined according to the method ISO 178:2010 on injection molded test specimens.

Tensile Modulus: determined according to the method ISO 527-3 on injection molded test specimens.

Charpy impact test: the Charpy impact value at different temperatures was determined according to ISO 179-1:2010 eA on injection molded test specimens.

Gloss: determined according to the method ASTM D2457-13 (angle 60°) on 60×60×2 mm injection molded plaques obtained according to the method ISO 294-3:2020.

Vicat softening temperature: determined according to the method ISO306 (9.81.N). Specimens were cut from the tensile injected bar (4 mm tick. 10 mm wide). At least 3 specimens were tested for each test. A silicon oil bath was used as testing environment. Start temperature: 25° C.; scan rate: 50° C./h; load: 1 Kg (9.81N).

Heat deflection temperature (HDT): determined according to the method ISO75B (0.45 Mpa).

### Raw Materials:

HECO1 and HECO2: prepared according to the procedure reported in Example 1 of Patent Cooperation Treaty Publication No. WO2007/042375, the differing polymerization conditions being reported in Table 1a, using a Ziegler-Natta catalyst system made from or containing:
a titanium solid catalyst component prepared with the procedure described in European Patent No. EP395083, Example 3, using diisobutyl phthalate as internal donor;
triethylaluminum (TEAL) as cocatalyst; and
dicyclopentyldimethoxysilane (DCPMS) as external donor.

TABLE 1a

| | | HECO1 | HECO2 |
|---|---|---|---|
| GPR1 | | | |
| H2/C3 | mol/mol | 0.03 | 0.05 |
| split | | 38.0 | 28.5 |
| C2# | wt. % | — | 2.5 |
| MFR# | g/10 min | 9.0 | 35.0 |
| XS# | wt. % | 2.0 | 5.0 |
| GPR2 | | | |
| H2/C2 | | 0.070 | 0.055 |
| C2/C3 + C2 | mol/mol | | 0.39 |
| split | | 33.0 | 37.5 |
| C2# | wt. % | 27.0 | 34.0 |
| MFR# | g/10 min | 1.4 | 1.1 |
| XS# | wt. % | 37.0 | 46.5 |
| GPR3 | | | |
| H2/C3 | mol/mol | 0.070 | 0.055 |
| C2/C2 + C3 | mol/mol | | 0.39 |
| split | | 29.0 | 34.0 |
| C2# | wt. % | 36.0 | 42.2 |
| MFR# | g/10 min | 0.8 | 0.4 |
| XS# | wt. % | 48.0 | 57.0 |
| XSIV# | dl/g | 3.7 | 4.1 |

H2 = hydrogen;
C3 = propylene;
C2 = ethylene;
# values measured on powders exiting from the respective reactors

The composition of the HECO 1 and HECO2 is reported in Table 1 b.

TABLE 1b

| | | HECO1 | HECO2 |
|---|---|---|---|
| Component (a) | wt. % | 38.0 | 28.5 |
| C2(a) | wt. % | — | 2.5 |
| XS(a) | wt. % | 2.0 | 5.0 |
| MFR(a) | g/10 min | 9.0 | 35.0 |
| Component (b) | wt. % | 62.0 | 71.5 |
| C2(b)* | wt. % | 58.0 | 58.0 |
| XS(b)* | wt. % | 76.2 | 77.7 |

Polypropylene composition (A)

| | | | |
|---|---|---|---|
| MFR(A) | g/10 min | 0.8 | 0.4 |
| XSIV(A) | dl/g | 3.7 | 4.1 |
| Flexural modulus | MPa | 330 | 130 |

*values calculated with the formulas:
C2(GPR3) = C2(a)W(a) + C2(b)W(b)
XS(GPR3) = XS(a)W(a) + XS(b)W(b)
wherein
C2(GPR3) and XS(GPR3) are the C2 content and the XS value measured at GPR3;
C2(b) and XS(b) are the C2 content and the XS of component (b);
C2(a) and XS(a) are the C2 content and XS value measured at GPR1;
W(a) = split(GPR1)/100;
W(b) = split(GPR2 + GPR3)/100.

The polymers obtained from the polymerization runs were further made from or containing the additive of 0.1 wt. % of Irgafos® 168 (tris(2,4-di-tert.-butylphenyl) phosphite).

rSBC1: recycled styrene-butadiene-styrene block copolymer obtained from mechanical recycling of a pre-consumer waste having MFR(B) of 7.4 g/10 min and 39.3% by weight of solubility in xylene at 25° C.

rSBC2: recycled styrene-butadiene-styrene block copolymer obtained from mechanical recycling of a pre-consumer waste having MFR(B) of 4.1 g/10 min and 88.0% by weight of solubility in xylene at 25° C. The r-SBC1 contains 3% by weight of talc, 3% by weight of polypropylene and 4% by weight of polyethylene.

### Examples E1-E2

The polypropylene composition HECO1 (corresponding to CE1) was melt blended with the sSBC1 (corresponding to CE2) in the proportion indicated in Table 2. The polymer particles were extruded under nitrogen atmosphere in a Berstorff 3 twin screw extruder, at a rotation speed of 250 rpm and a melt temperature of 200°-250° C.

The measured properties are reported in Table 2.

TABLE 2

| | | | CE1 | CE2 | E1 | E2 |
|---|---|---|---|---|---|---|
| HECO1 | | wt. % | 100 | — | 90 | 80 |
| rSBC1 | | wt. % | — | 100 | 10 | 20 |
| MFR(I) | | g/10 min | 0.8 | 7.4 | 0.74 | 0.72 |
| Gloss (60° on plaques) | | | 18.0 | — | 19.0 | 23.8 |
| Tensile modulus | | MPa | 293 | 220 | 310 | 340 |
| Vicat 9.81N | | ° C. | 68.5 | 81.5 | 70.5 | 71.5 |
| HDT 0.45 MPa | | ° C. | 50.5 | 47.0 | 49.5 | 48.0 |
| Charpy impact | 23° C. | kJ/m² | 71.7 | 61.6 | 72.1 | 58.4 |
| | 0° C. | kJ/m² | 85.9 | — | 86.6 | 75.1 |
| | −20° C. | kJ/m² | 105.0 | 93.6 | 103.4 | 101.5 |

### Examples E3-E4

The polypropylene composition HECO2 (corresponding to CE3) was melt blended with the sSBC1 (corresponding to CE2) in the proportion indicated in Table 3. The polymer particles were extruded under nitrogen atmosphere in a Berstorff 3 twin screw extruder, at a rotation speed of 250 rpm and a melt temperature of 200°-250° C.

The measured properties are reported in Table 3.

TABLE 3

| | | | CE3 | CE2 | E3 | E4 |
|---|---|---|---|---|---|---|
| HECO2 | | wt. % | 100 | 1 | 90 | 80 |
| rSBC1 | | wt. % | — | 100 | 10 | 20 |
| MFR(I) | | g/10 min | 0.4 | 7.4 | 0.40 | 0.40 |
| Gloss (60° on plaques) | | | 33.9 | — | 35.8 | 29.6 |
| Tensile modulus | | MPa | 70 | 220 | 100 | 120 |
| Vicat 9.81N | | ° C. | 44.0 | 81.5 | 46.0 | 48.7 |
| HDT 0.45 MPa | | ° C. | 38.5 | 47.0 | 41.0 | 45.5 |
| Charpy impact | 23° C. | kJ/m² | 33.5 | 61.6 | 35.4 | 36.8 |
| | 0° C. | kJ/m² | 26.9 | — | 43.3 | 47.4 |
| | −20° C. | kJ/m² | 37.3 | 93.6 | 66.2 | 64.6 |

### Examples E5-E6

The polypropylene composition HECO2 (corresponding to CE3) was melt blended with the sSBC2 (corresponding to CE4) in the proportion indicated in Table 4. The polymer particles were extruded under nitrogen atmosphere in a Berstorff 3 twin screw extruder, at a rotation speed of 250 rpm and a melt temperature of 200°-250° C.

The measured properties are reported in Table 4.

TABLE 4

| | | | CE3 | CE4 | E5 | E6 |
|---|---|---|---|---|---|---|
| HECO2 | | wt. % | 100 | — | 90 | 80 |
| rSBC2 | | wt. % | — | 100 | 10 | 20 |
| MFR(I) | | g/10 min | 0.4 | 4.1 | 0.33 | 0.45 |
| Gloss (60° on plaques) | | | 33.9 | — | 29.5 | 29.3 |
| Tensile modulus | | MPa | 70 | 42 | 78 | 80 |
| Vicat 9.81N | | ° C. | 44.0 | 42.4 | 44.5 | 44.0 |
| HDT 0.45 MPa | | ° C. | 38.5 | 41.0 | 40.0 | 40.5 |
| Charpy impact | 23° C. | kJ/m² | 33.5 | — | 33.8 | 29.7 |
| | 0° C. | kJ/m² | 26.9 | — | 35.3 | 31.4 |
| | −20° C. | kJ/m² | 37.3 | — | 58.3 | 45.2 |

What is claimed is:

1. A polyolefin composition (I) comprising:
(A) from 70% to 97% by weight of a polypropylene composition comprising:
from 20% to 45% by weight of a polymer fraction (a)
comprising a propylene polymer selected from the group consisting of propylene homopolymers, propylene copolymers and combinations thereof, and
having solubility in xylene at 25° C. (XS(a)) equal to or lower than 10.0% by weight, based on the weight of the fraction (a);
wherein the propylene copolymer containing up to and including 15.0% by weight, based on the weight of the propylene copolymer, of units derived from a comonomer selected from the group consisting of ethylene and a CH₂═CHR alpha-olefin,
wherein R is a linear or branched C2-C8 alkyl group; and
from 55% to 80% by weight of a polymer fraction (b)
comprising a copolymer of ethylene with a comonomer selected from the group consisting of propylene and a CH₂═CHR alpha-olefin, wherein R is a linear or branched C2-C8 alkyl group, and combinations thereof, and
having solubility in xylene at 25° C. (XS(b)) equal to or greater than 60.0% by weight, based on the weight of the fraction (b),
wherein the ethylene copolymer contains more than 50.0% by weight of units derived from ethylene, based on the weight of the ethylene copolymer,
wherein the amounts of fractions (a) and (b) are based on the total weight of (a)+(b), and
(B) from 3% to 30% by weight of a recycled styrene block copolymer, having a melt flow rate MFR(B) (ISO 1133-1:2011, 230° C./2.16 kg) ranging from 2.0 to 15.0 g/10 min,
wherein the amounts of (A) and (B) are based on the total amount of (A)+(B).

2. The polyolefin composition (I) according to claim 1 comprising:
from 75% to less than 95% by weight of the polypropylene composition (A), and
from more than 5% to 25% by weight of the recycled styrene block copolymer (B),
wherein the amounts of (A) and (B) are based on the total amount of (A)+(B).

3. The polyolefin composition (I) according to claim 1, wherein the polypropylene composition (A) comprises:
from 20% to 45% by weight of a polymer fraction (a)
comprising a propylene polymer selected from the group consisting of propylene homopolymers, propylene copolymers and combinations thereof, and
having solubility in xylene at 25° C. (XS(a)) equal to or lower than 10.0% by weight, based on the weight of the fraction (a);
wherein the propylene copolymer contains up to and including 15.0% by weight, based on the weight of the propylene copolymer, of units derived from a comonomer selected from the group consisting of ethylene and a CH₂═CHR alpha-olefin, wherein R is a linear or branched C2-C8 alkyl group; and
from 55% to 80% by weight of a polymer fraction (b)
comprising a copolymer of ethylene with a comonomer selected from the group consisting of propylene, a CH₂═CHR alpha-olefin, wherein R is a linear or branched C2-C8 alkyl group, and combinations thereof, and
having solubility in xylene at 25° C. (XS(b)) equal to or greater than 60.0% by weight, based on the weight of the fraction (b),
wherein the ethylene copolymer contains more than 50.0% by weight of units derived from ethylene, based on the weight of the ethylene copolymer,
wherein the amounts of fractions (a) and (b) are based on the total weight of (a)+(b).

4. The polyolefin composition (I) according to claim 1, wherein the fraction (a) has at least one of the following properties:
comprising a propylene polymer selected from the group consisting of propylene homopolymers, propylene copolymers and combinations thereof, wherein the propylene copolymer containing up to and including 15.0% by weight, based on the weight of the propylene copolymer, of units derived from a comonomer selected from the group consisting of ethylene, butene-1, hexene-1 and combinations thereof; or
a melt flow rate MFR(a) (ISO 1133-1:2011, 260° C./2.16 kg) ranging from 2.0 to 70 g/10 min.

5. The polyolefin composition (I) according to claim 1, wherein
the fraction (b) comprises a copolymer of ethylene with a comonomer selected from the group consisting of propylene, butene-1, -hexene-1 and combinations thereof, and
the ethylene copolymer containing more than 50.0% by weight of units derived from the comonomer.

6. The polyolefin composition (I) according to claim 1, wherein the polypropylene composition (A) has at least one of the following properties:
a melt flow rate MFR(A) ranging from 0.05 to 5.0 g/10 min; or
an intrinsic viscosity of the xylene soluble fraction at 25° C. X(A) equal to or greater than 2.0 dl/g; or
a flexural modulus equal to or lower than 600 MPa, determined according to the method ISO 178:2010.

7. The polyolefin composition (I) according to claim 1, wherein the recycled styrene block copolymer (B) comprises a block copolymer selected from the group consisting of polystyrene-polybutadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS) and mixtures thereof.

8. The polyolefin composition (I) according to claim 1, wherein the recycled styrene block copolymer (B) is a recycled polystyrene-polybutadiene-polystyrene (rSBS) block copolymer originating from a pre-consumer waste.

9. The polyolefin composition (I) according to claim 1, wherein the recycled styrene block copolymer (B) comprises up to and including 20.0% by weight, based on the weight of component (B), of a material selected from the group consisting of polypropylene, polyethylene, an inorganic filler, and mixtures thereof.

10. The polyolefin composition (I) according to claim 1, wherein the recycled styrene block copolymer (B) has at least one of the following properties:
a melt flow rate MFR(B) (ISO 1133-1:2011, 230° C./2.16 kg) ranging from 2.0 to 12.0 g/10 min; or
a tensile modulus ranging from 30 to 400 Mpa, determined according to the method ISO 527-3; or
a Charpy impact value at 23° C., determined according to the method ISO 179-1eA, equal to or greater than 50 kJ/m²; or
a Charpy impact value at −20° C., determined according to the method ISO 179-1eA, equal to or greater than 80 kJ/m²; or
a Vicat softening temperature, determined according to the method ISO 306 (9.81N), in the range 35°-95° C.; or
a Heat Deflection Temperature (HDT), determined according to the method ISO075B (0.45 Mpa, Flat, 48 h), equal to or lower than 55° C.

11. The polyolefin composition (I) according to claim 1, having a melt flow rate MFR(I) (ISO 1133-1:2011, 230° C./2.16 kg) ranging from 0.1 to 5.0 g/10 min.

12. The polyolefin composition (I) according to claim 1, having a tensile modulus Tmod(I), wherein the tensile modulus Tmod(I) fulfills the following equation:
$$Tmod ( i ) \geq Tmod ( A ) W ( A ) + Tmod ( B ) W ( B )$$
wherein
Tmod(I) is the tensile modulus of the polyolefin composition (I), Tmod(A) is the tensile modulus of the polypropylene composition (A), W(A) is the relative amount of the polypropylene composition (A) in the polyolefin composition (I), Tmod(B) is the tensile modulus of the recycled styrene block copolymer (B) and W(B) is the relative amount of the recycled styrene block copolymer (B) in the polyolefin composition (I);
wherein the tensile modulus is determined according to the method ISO 527-3; and
wherein the relative amounts of (A) and (B) are referred to the sum of components (A)+(B).

13. An article comprising the polyolefin composition (I) according to claim 1.

14. The article according to claim 13, wherein the article is an extruded article.

15. The article according to claim 13, wherein the article is artificial leather.
